(19) United States
(12) Patent Application Publication
(10) Pub. No.: US 2010/0049706 A1
(43) Pub. Date: Feb. 25, 2010

(54) WORK HISTORY MANAGEMENT APPARATUS AND MANAGEMENT METHOD THEREOF

(75) Inventors: Daisuke KOMAKI, Yokohama (JP); Sachio Minami, Yokohama (JP)

Correspondence Address: FOLEY AND LARDNER LLP;SUITE 500, 3000 K STREET NW, WASHINGTON, DC, 20007, US

(73) Assignee: HITACHI, LTD.

(21) Appl. No.: 12/507,531

(22) Filed: Jul. 22, 2009

(30) Foreign Application Priority Data
Aug. 22, 2008 (JP) 2008-214279

(51) Int. Cl. G06F 17/30; G06F 17/40; G06N 5/02

(52) U.S. Cl. 707/5; 706/54; 707/3; 707/E17.046; 707/E17.014

(57) ABSTRACT

There is a need for facilitating configuration of the right to reference varied work histories and searching for work histories. A work history management apparatus according to an embodiment of the invention includes: a work history classification section that classifies a work history in accordance with a content of the work history and assigns a classification identifier; a work history registration section that associates the classification identifier with the work history and stores the work history in a storage device; and a work history reference section that responds to a work history reference request from a user, references a reference condition associating a user capable of referencing the work history with the classification identifier, and searches for the work history stored in the storage device so as to be able to be referenced by the user and correspond to the classification identifier.

### BACKGROUND OF THE INVENTION

The present invention relates to a work history management apparatus and management method thereof for registering work history information and referencing work history information provided with access control.

A technology for controlling access to data is described in Japanese Patent Application Laid-Open Publication No. 2003-36207. The technology described in Japanese Patent Application Laid-Open Publication No. 2003-36207 maintains multiple pieces of data and stores the right to access each of the multiple pieces of data for accessing users. When a request to access data occurs, the access right is used to determine whether or not an accessing user is permitted to access the requested data.

### SUMMARY OF THE INVENTION

It is characteristic of sharing the work history information that the information is so diversified and so increased in quantity as to cover targets of the information, work types, work places, workers, and work dates. The access control over the information is also diversified and complicated. Let us consider an example of sharing the shipping work history. Various access controls may be necessary for the shipping work history that may be referenced from: a company that undertakes the shipping work; a company as a destination of the shipping work with or without limitation on a specified reference time period; and an industry group under a certain condition such as permission to reference only the work history about recalled products. Japanese Patent Application Laid-Open Publication No. 2003-36207 provides access control by assigning the right to access each one of data. However, there are some problems. When the access control described in Japanese Patent Application Laid-Open Publication No. 2003-36207 is used for sharing the work history, various situations need to be considered, making it difficult for users to individually set the access right. The access control is unavailable when setting the access right is based on unknown information such as the reference time or conditions of goods to be processed.

It is therefore an object of the present invention to provide a work history management apparatus and management method of the same capable of facilitating setup of the right to reference or access diversified work histories and searching for the work histories.

A work history management apparatus according to an embodiment of the invention includes: a work history classification section that classifies a work history in accordance with a content of the work history and assigns a classification identifier; a work history registration section that associates the classification identifier with the work history and stores the work history in a storage device; and a work history reference section that responds to a work history reference request from a user, references a reference condition associating a user capable of referencing the work history with the classification identifier, and searches for the work history stored in the storage device so as to be able to be referenced by the user and correspond to the classification identifier.

According to a preferred aspect of the invention, a content of the work history contains a work subject, a work date, a work place, a work object, and a work content.

Another aspect of the invention provides a work history management apparatus including: a storage device for storing a reference condition that associates a work history with a classification identifier corresponding to a user capable of referencing the work history and a content of the work history; an input device for accepting a work history reference request from a user; a central processing unit that assigns the classification identifier to the work history in accordance with a content of the work history, stores the work history in the storage device in association with the classification identifier assigned to the work history, references a reference condition stored in the storage device in response to the work history reference request, and searches for the work history stored in the storage device so as to be able to be referenced by the user and correspond to the classification identifier; and an output device for outputting the searched-for work history.

Still another aspect of the invention provides a work history management method. According to the method, a central processing unit is connected with a storage device for storing a reference condition that associates a work history with a classification identifier corresponding to a user capable of referencing the work history and a content of the work history, an input device for accepting a work history reference request from a user, and an output device. The central processing unit assigns the classification identifier to the work history in accordance with a content of the work history, stores the work history in the storage device in association with the classification identifier assigned to the work history, references a reference condition stored in the storage device in response to the work history reference request, searches for the work history stored in the storage device so as to be able to be referenced by the user and correspond to the classification identifier, and outputs the searched-for work history to the output device. The invention may be capable of facilitating configuration of the right to reference or access varied work histories and searching for work histories.

These and other features, objects and advantages of the present invention will become more apparent from the following description when taken in conjunction with the accompanying drawings.

### BRIEF DESCRIPTION OF THE DRAWINGS

FIG. 1 shows an overall configuration of a work history management apparatus;

FIG. 2 shows an example of a work history table;

FIG. 3 shows an example of a master table concerning objects;

FIG. 4 shows an example of a work history classification definition;

FIG. 5 shows an example of a reference condition definition;

FIG. 6 shows an example of a state table;

FIG. 7 shows a flow chart for classifying and registering a work history; and

FIG. 8 shows a flow chart for adding a reference condition and referencing a work history.

### DESCRIPTION OF THE EMBODIMENTS

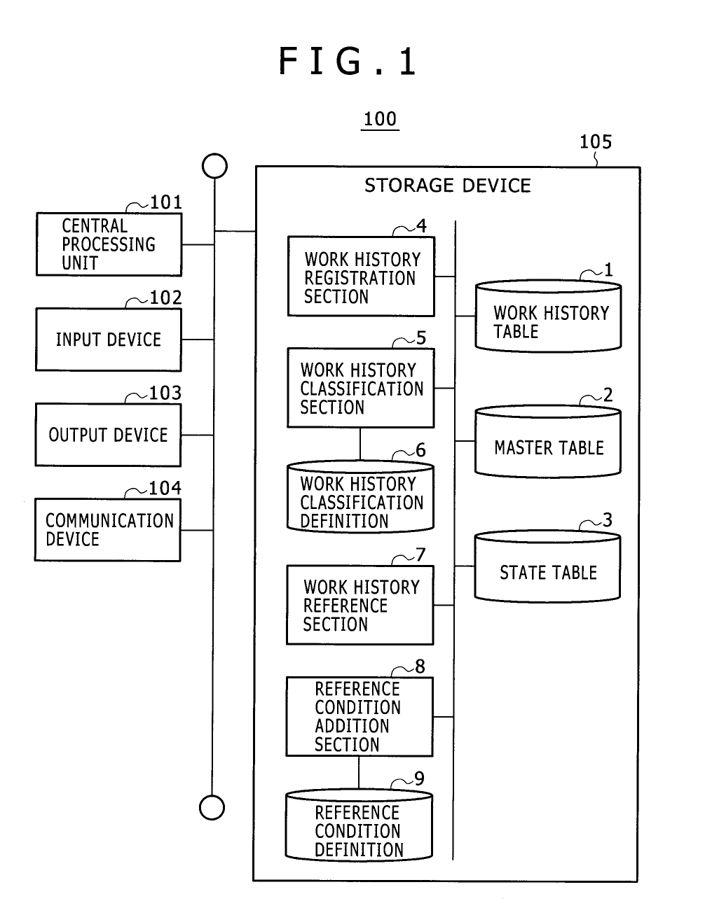

Embodiments of the present invention will be described in further detail with reference to the accompanying drawings. FIG. 1 diagrams an overall configuration of a work history management apparatus 100. As shown in FIG. 1, the work history management apparatus 100 includes a central processing unit (CPU), an input device 102, an output device 103, a communication device 104, and a storage device 105. The central processing unit 101 executes processing sections to be described later. The input device 102 includes a keyboard, a mouse, a barcode reader, or an RFID reader. The output device 103 includes a display. The communication device includes wired or wireless Ethernet (registered trademark). The storage device 105 includes a hard disk for storing programs or database tables. These components are connected with a bus.

The storage device 105 includes processing sections such as a work history registration section 4, a work history classification section 5, a work history reference section 7, and a reference condition addition section 8 for a work history table 1 such as a database table, a master table 2, a state table 3, and a program. The storage device 105 also stores work history classification definition 6 and reference condition definition 9 for a file or a database table that contains setup information.

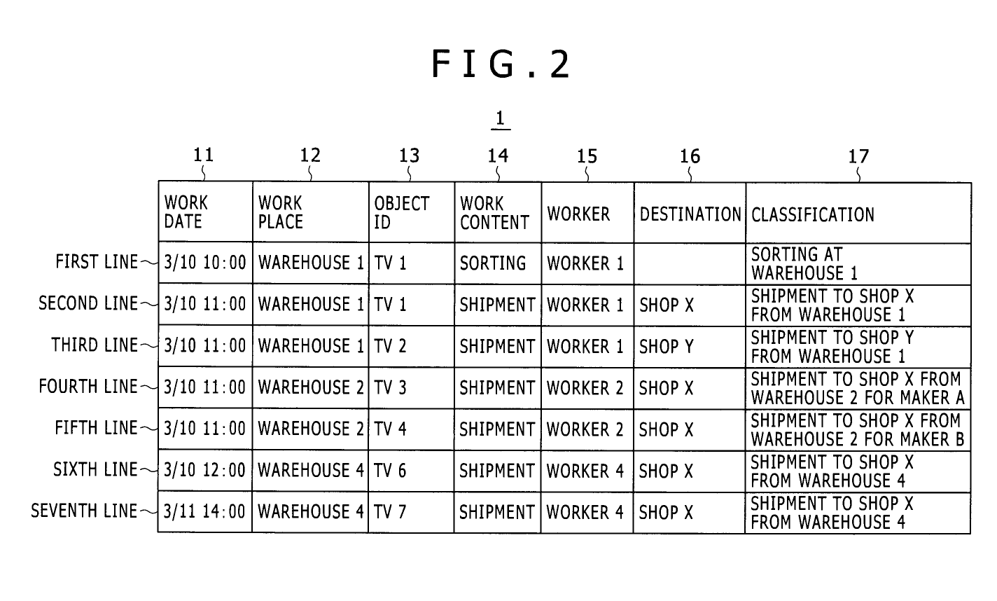

The work history table 1 provides a database for tables that contain work histories. The following describes a work history with reference to an example of the work history table 1 as shown in FIG. 2. The work history records works on objects. The work history contains such information as a work date 11, a work place 12, an object ID 13 as an identifier of a work object, a work content 14, a worker 15 indicative of information about a person, a corporation, or a department in charge of a work, and a destination 16 indicative of a place where an object is to be placed or moved after the work.

For example, the first line in FIG. 2 indicates a “sorting” work for “TV1” conducted by “worker 1” in “warehouse 1” at “10:00 AM on March 10”. The second line indicates a “shipment” work for “TV1” conducted by “worker 1” in “warehouse 1” at “11:00 AM on March 10”. The line also indicates that the object is scheduled to be moved to “shop X” after the shipment. The work history table 1 in the storage device 105 stores and maintains the work history supplemented by classification 17 of the work history of reference control.

The work history records a work in terms of who (worker 15 that may or may not be a person as a subject of the work), when (work date 11), where (work place 12), what (object ID 13 as a work object not limited to a tangible entity), and how (work content 14 or a work name indicative of work content). The destination 16 is included on the premise that a work object is often moved (transported) after completion of the work content 14. This aims at recording the work history in association with the work prior to the move (transportation) without recording the move (transportation) as an independent work. It is possible to decrease the capacity of the work history table 1 and reduce the amount of information because the move (transportation) is not recorded as an independent work. Users may easily reference the work history.

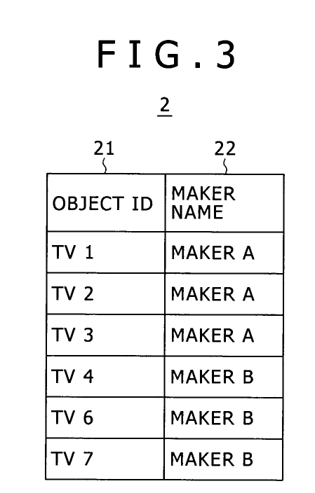

The master table 2 provides a database of tables and the like that maintain information about workers and objects associated with the work history. FIG. 3 shows an example of the master table concerning objects. A maker name 22 indicates names of makers that manufacture products assigned an object ID 21. The first line shows “maker A” as the name of a maker that manufactures a product with object ID “TV1”.

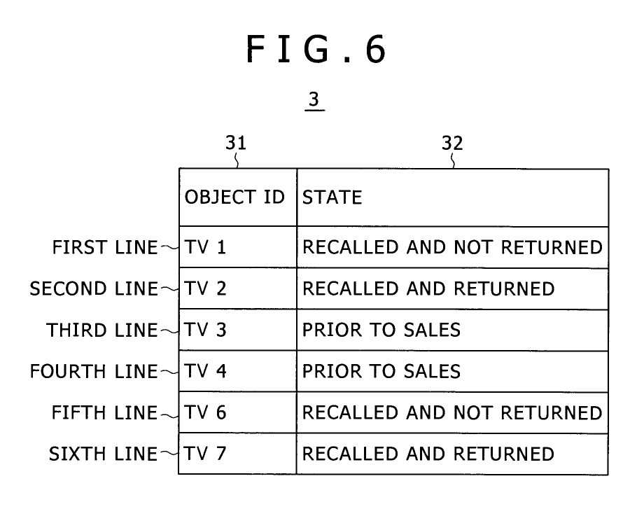

The state table 3 provides a database of tables and the like that maintain states of objects in the work history. State examples include a repairing or recalling state. The state table 3 maintains the most recent repairing or recalling state corresponding to each of products. FIG. 6 shows an example of the state table 3. A state 32 is maintained as the current state of an object assigned an object ID 31. The first line shows that “TV1” is “recalled and not returned”. The second line shows that “TV2” is “recalled and returned”.

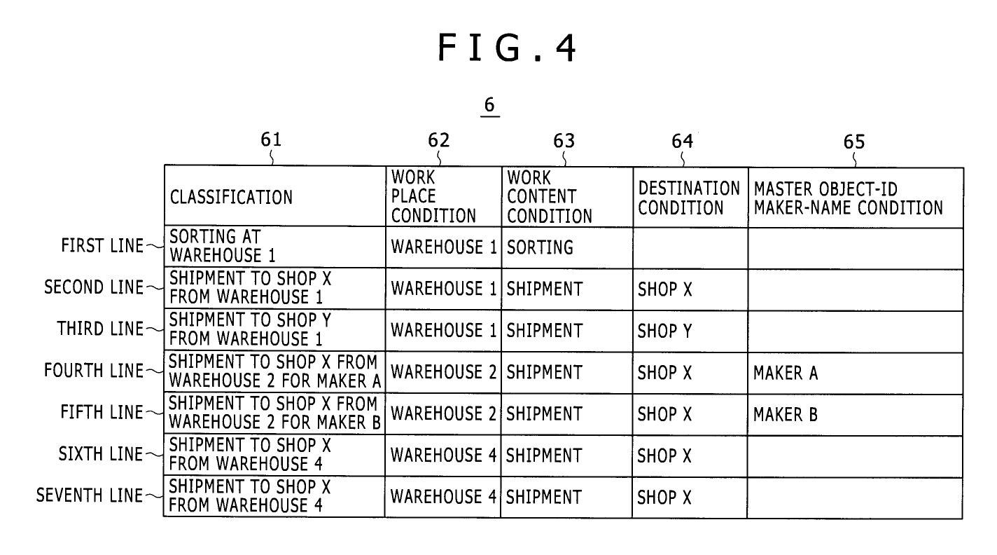

The work history classification definition 6 is equivalent to a file or a table that maintains conditions for classifying the work history according to the contents of the work history. FIG. 4 shows an example of the work history classification definition 6. In this example, the work history classification definition 6 contains conditions for the work history such as a work place condition 62, a work content condition 63, a destination condition 64, a master object-ID maker-name condition 65 as a condition of a master associated with the work history, and a classification 61 attached to the work history that matches the conditions.

The second line defines addition of the classification “shipment to shop X from warehouse 1” to the work history containing “warehouse 1” as the work place, “shipment” as the work content, and “shop X” as the shipment destination. The fourth line defines addition (assignment) of the classification “shipment to shop X from warehouse 2 for maker A” to the work history containing “warehouse 2” as the work place, “shipment” as the work content, “shop X” as the shipment destination, and “maker A” as a manufacturer of a product (object) targeted for the work.

The reference condition definition 9 is equivalent to a file or a table that maintains reference conditions such as work history classifications referable for each of users or user groups.

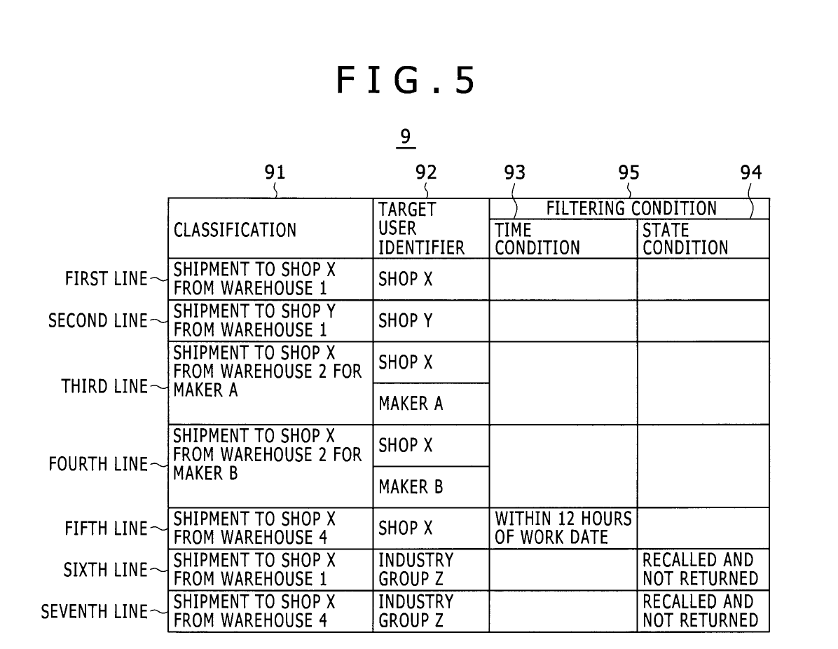

FIG. 5 shows an example of the reference condition definition 9. In this example, a target user identifier 92 defines a user referable in the work history corresponding to a classification 91. A time condition 93 defines an referable time range. A state condition 94 defines a condition about a state. FIG. 5 shows a filtering condition 95 including the time condition 93 and the state condition 94.

The first line indicates that the work history assigned the classification “shipment to shop X from warehouse 1” is referable for a user whose user identifier is “shop X”. The third line indicates that the work history assigned the classification “shipment to shop X from warehouse 2 for maker A” is referable for a user whose user identifier is “shop X” or “maker A”.

The fifth line indicates that the work history assigned the classification “shipment to shop X from warehouse 4” is referable for a user having the user identifier “shop X” only within 12 hours from the work date. The sixth line indicates that a user having the user identifier “industry group Z” can reference the work history that is assigned the classification “shipment to shop X from warehouse 1” and is associated with an object “recalled and not returned” at the time of the reference.

According to the definitions on the first and sixth lines, the work history assigned the classification “shipment to shop X from warehouse 1” is basically referable for only the user having the user identifier “shop X”. When the object targeted for the work is “recalled and not returned” at the time of the reference, the work history is referable from not only “shop X” but also “industry group Z” that monitors recalls.

According to the example table in FIG. 5, each line contains referable conditions to be OR'ed with each other. The work history is referable when any one of the conditions is satisfied. The table may contain non-referable conditions that may be AND'ed with each other. It may be also preferable to add an referable/non-referable item so as to be able to define referable and non-referable conditions.

The work history classification section 5 is a processing program that adds the classification to each of work histories that are input from the input device 102 or are received by the communication device 104. The classification is added in accordance with classification conditions defined in the work history classification definition 6. The work history registration section 4 is a processing program that uses the work history table 1 to register a work history supplied with a work classification identifier by the work history classification section 5. The reference condition addition section 8 is a processing program that adds a reference condition to a work history reference request that is supplied from the input device 102 or is received by the communication device 104. The reference condition is added in accordance with the user identifier supplied or received along with the work history reference request and the reference condition definition 9. The work history reference section 7 acquires a work history from the work history table 1 in accordance with the work history reference request supplied with the reference condition by the reference condition addition section 8. The work history reference section 7 outputs the work history to the output device 103 or the communication device 104.

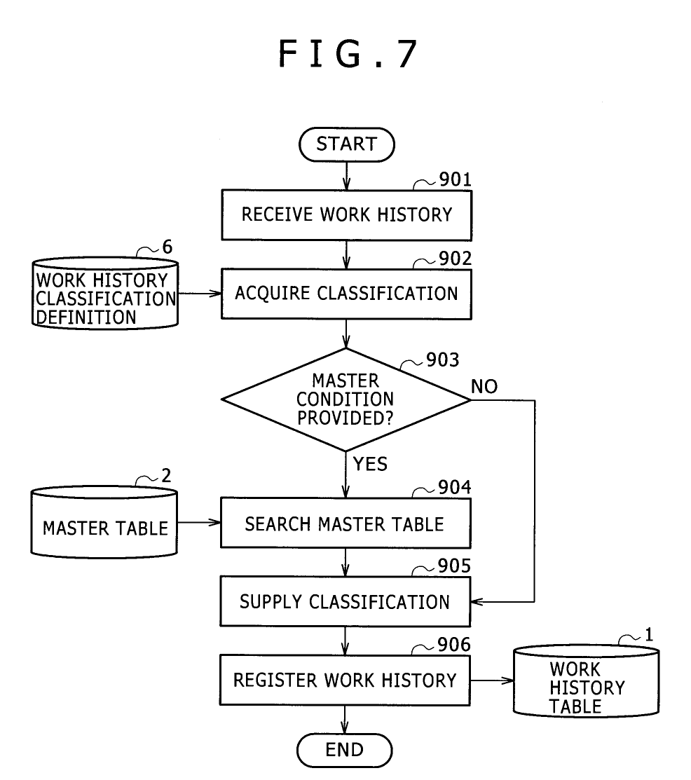

The following describes processes of the work history management apparatus 100 in the order of a registration process and a reference process. The registration process for work histories will be described first. To register a work history, the work history classification section 5 adds the classification to the work history. The work history registration section 4 registers the work history to the work history table 1. A flow chart in FIG. 7 is mainly used to describe the processes of classifying and registering work histories with reference to the example of the work history classification definition 6 in FIG. 4, the example of the master table 2 concerning objects in FIG. 3, and the example of the work history table 1 in FIG. 2.

The following first describes an example of classifying a work history that is assigned “10:00 on March 10” as the work date, “warehouse 1” as the work place, “TV1” as the object, “sorting” as the work content, and “worker 1” as the worker. The process receives the work history (Step 901). The process searches the work history classification definition 6 shown in FIG. 4 for a classification that matches the received work history (Step 902). Only the classification “sorting at warehouse 1” on the first line contains “warehouse 1” as the work place condition 62 and “sorting” as the work content condition 63 and matches the received work history. The process determines whether or not the matched classification contains a condition requiring reference to the master (Step 903). Such condition may correspond to the master object-ID maker-name condition 65 according to the example in FIG. 4. The classification “sorting at warehouse 1” on the first line does not contain the corresponding condition. The process then proceeds to Step 905.

The process determines “sorting at warehouse 1” as the classification to be added to the received work history. The work history registration section 4 registers the work history content to the columns from the work date 11 to the destination 16 as seen from the first line of the work history table 1 in FIG. 2. The process registers the classification “sorting at warehouse 1” corresponding to the classification 17 for the work history (Step 905).

The process similar to that performed on the first line is performed for work histories on the second, third, sixth, and seventh lines with reference to the columns from the work date 11 to the destination 16 in FIG. 2. The process identifies the classification “shipment to shop X from warehouse 1” on the second line, the classification “shipment to shop Y from warehouse 1” on the third line, the classification “shipment to shop X from warehouse 4” on the sixth line, and the classification “shipment to shop X from warehouse 4” on the seventh line. The work histories do not contain the master object-ID maker-name condition 65 as the condition that requires to reference the master. The process registers the work histories by adding the classification 17 to the second, third, sixth, and seventh lines of the work history table as shown in FIG. 2.

The following describes an example of classifying a work history that is assigned “11:00 on March 10” as the work date, “warehouse 2” as the work place, “TV3” as the object, “shipment” as the work content, “worker 2” as the worker, and “shop X” as the destination. The process receives the work history (Step 901). The process searches the work history classification definition 6 shown in FIG. 4 for a classification that matches the received work history (Step 902). The classification “shipment to shop X from warehouse 2 for maker A” on the fourth line and the classification “shipment to shop X from warehouse 2 for maker B” on the fifth line contain “warehouse 2” as the work place condition 62, “shipment” as the work content condition 63, and “shop X” as the destination condition 64. These classifications match the received work history.

As the master object-ID maker-name condition 65, “maker A” and “maker B” are defined for the classifications “shipment to shop X from warehouse 2 for maker A” on the fourth line and “shipment to shop X from warehouse 2 for maker B” on the fourth line, respectively. The master object-ID maker-name condition 65 requires to reference the master. The process determines provision of the master condition (Step 903) and proceeds to Step 904. In accordance with the master object-ID maker-name condition 65, the process references the master table concerning objects in FIG. 3 that defines correspondence between the object ID and the maker name. The process acquires the maker name “maker A” on the third line that corresponds to the object ID “TV3” in the received work history (Step 904).

As seen from the master object-ID maker-name condition 65 for the fourth and fifth lines of the work history classification definition 6 in FIG. 4 acquired at Step 902, “maker A” matches only the classification “shipment to shop X from warehouse 2 for maker A” on the fourth line. The process assumes “shipment to shop X from warehouse 2 for maker A” to be the classification that matches the received work history. The process determines “shipment to shop X from warehouse 2 for maker A” to be added to the received work history. The work history registration section 4 registers the work history content to the columns from the work date 11 to the destination 16 as seen from the fourth line of the work history table 1 in FIG. 2. The process registers the classification “shipment to shop X from warehouse 2 for maker A” corresponding to the classification 17 for the work history (Step 905).

The process similar to the above is performed to classify a work history that is assigned “11:00 on March 10” as the work date, “warehouse 2” as the work place, “TV4” as the object, “shipment” as the work content, “worker 2” as the worker, and “shop X” as the destination. The maker name is identified as “maker B” because “TV4” corresponds to the fourth line of the master table in FIG. 3 concerning objects. The matching classification is “shipment to shop X from warehouse 2 for maker A” on the fifth line of the work history classification definition 6 in FIG. 4 including such conditions as “warehouse 2” as the work place, “shipment” as the work content, and “shop X” as the destination. The process registers the work history as shown on the fifth line of the work history table 1 in FIG. 2.

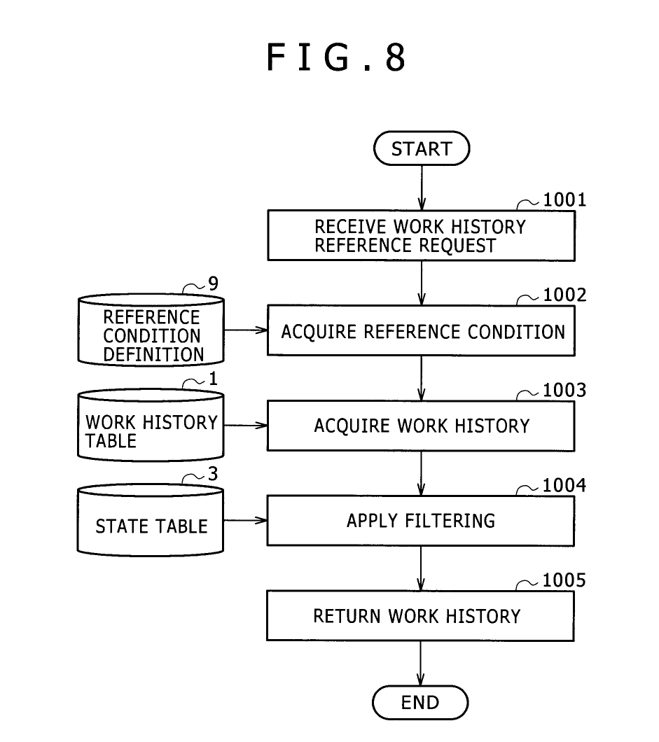

The reference process for work histories will then be described. To reference a work history, the reference condition addition section 8 supplies a work history reference request with a reference condition concerning referable work histories. The work history reference section 7 performs the work history reference request supplied with the reference condition to limit referable work histories for acquiring a targeted work history. A flow chart in FIG. 8 is mainly used to describe the processes of supplying reference conditions and referencing a work history with reference to the example of the reference condition definition 9 in FIG. 5, the example of the master table 2 concerning workers in FIG. 3, the example of the state table in FIG. 6, and the example of the work history table 1 in FIG. 2.

The following describes an example where a user having the user identifier “shop X” issues a work history reference request at “15:00 on March 11” for “acquiring all work histories”. The process receives the issued work history reference request (Step 1001). The process acquires reference conditions containing the user identifier “shop X” (Step 1002). The process acquires classifications containing “shop X” as the targeted user identifier 92 from the reference condition definition 9 in FIG. 5. The acquired classifications include “shipment to shop X from warehouse 1” on the first line, “shipment to shop X from warehouse 2 for maker A” on the third line, “shipment to shop X from warehouse 2 for maker B” on the fourth line, and “shipment to shop X from warehouse 4” on the fifth line.

The process then supplies the received work history reference request with the acquired classifications as a condition and searches the work history table 1 (Step 1003). Specifically, the work history reference request aims to “acquire all work histories”. The condition is to match any of the classifications “shipment to shop X from warehouse 1”, “shipment to shop X from warehouse 2 for maker A”, “shipment to shop X from warehouse 2 for maker B”, and “shipment to shop X from warehouse 4”. The process acquires the work histories on the second, fourth, fifth, sixth, and seventh lines matching the condition from the work history table 1 in FIG. 2.

The following describes another example of the work history reference request that specifies the user having the user identifier “shop X”. In addition to the above-mentioned example, the condition may specify the user having the user identifier “shop X” combined with the work place “warehouse 1”. The condition specifies the work place “warehouse 1” and any of the classifications “shipment to shop X from warehouse 1”, “shipment to shop X from warehouse 2 for maker A”, “shipment to shop X from warehouse 2 for maker B”, and “shipment to shop X from warehouse 4”. The condition matches only the second line of the work history table 1 in FIG. 2.

The process then applies the filtering condition 95 for the acquired reference conditions to the acquired work histories (Step 1004). Of the acquired reference conditions, the filtering condition contains the time condition 93 “within 12 hours of work date” for the classification “shipment to shop X from warehouse 4” on the fifth line of the reference condition definition 9 in FIG. 5. The process applies the time condition 93 “within 12 hours of work date” to the work histories on the sixth and seventh lines of the work history table 1 in FIG. 2 listing the acquired work histories. As mentioned above, the current time is “15:00 on March 11” when the work history reference request is issued. The work date 11 needs to be “3:00 or later on March 11” as the condition. The work history on the sixth line contains the work date “12:00 on March 10”. The work history on the seventh line contains the work date “14:00 on March 11”. The work history on the sixth line does not match the filtering condition.

As mentioned above, the user having the user identifier “shop X” issues the work history reference request for “acquiring all work histories” at “15:00 on March 11”. As a response, the process returns the work histories on the second, fourth, fifth, and seventh lines of the work history table 1 in FIG. 2 containing the shipment to the shop X (Step 1005). Though containing the shipment to the shop X, the work history on the sixth line does not match the time condition 93 that specifies a referable time within 12 hours from the work conducted. Accordingly, the user having the user identifier “shop X” cannot acquire the work history on the sixth line.

In this example, the time condition 93 in FIG. 5 is applied at the filtering stage (Step 1004). The time condition 93 may be applied at the work history acquisition stage (Step 1003). In this case, the work history table 1 may be searched without filtering based on a condition under which the classification is any of “shipment to shop X from warehouse 1”, “shipment to shop X from warehouse 2 for maker A”, and “shipment to shop X from warehouse 2 for maker B” or the classification is “shipment to shop X from warehouse 4” and the work date is “3:00 or later on March 11”. The same result is generated independently of whether search results are filtered or the filtering condition is added to the search condition for searching.

The following describes an example where the user having the user identifier “maker A” issues a work history reference request for “acquiring all work histories”. The process receives the issued work history reference request (Step 1001). The process acquires a reference condition that corresponds to the user identifier “maker A” (Step 1002). From the reference condition definition 9 in FIG. 5, the process acquires the classification “shipment to shop X from warehouse 2 for maker A” on the third line where the user identifier 92 contains “maker A”.

The process supplies the received work history reference request with the acquired classification as a condition to search the work history table 1 (Step 1003). Specifically, the work history reference request aims to “acquire all work histories”. The process uses the classification “shipment to shop X from warehouse 2 for maker A” as the condition and acquires the work history on the fourth line matching the condition from the work history table 1 in FIG. 2. The process skips the filtering (Step 1004) because the acquired reference condition does not contain the filtering condition 95. The user having the user identifier “maker A” issues the work history reference request for “acquiring all work histories. As a response, the process returns the shipment of a product manufactured by the maker A, i.e., “shipment” of “TV3” from “warehouse 2” to “shop X” conducted by “worker 2” at “11:00 on March 10” (Step 1005).

The following describes an example where the user having the user identifier “industry group Z” issues a work history reference request for “acquiring all work histories”. The process receives the issued work history reference request (Step 1001). The process acquires a reference condition that corresponds to the user identifier “industry group Z” (Step 1002). From the reference condition definition 9 in FIG. 5, the process acquires the classification “shipment to shop X from warehouse 1” on the sixth line and the classification “shipment to shop X from warehouse 4” on the seventh line where the user identifier 92 contains “industry group Z”.

The process supplies the received work history reference request with the acquired classification as a condition to search the work history table 1 (Step 1003). Specifically, the work history reference request aims to “acquire all work histories”. The process uses the classification “shipment to shop X from warehouse 1” or “shipment to shop X from warehouse 4” as the condition and acquires the work history on the second, sixth, and seventh lines matching the condition from the work history table 1 in FIG. 2.

The process applies the filtering condition 95 out of the acquired reference conditions to the acquired work histories (Step 1004). The acquired reference conditions contain “recalled and not returned” as the state condition 94 belonging to the filtering condition. Namely, the state condition 94 defines that the targeted object is “recalled and not returned” at the reference time. The process acquires current states of the object IDs “TV1”, “TV6”, and “TV7” in the acquired work histories from the state table in FIG. 6. As seen from FIG. 6, “TV1” and “TV6” are “recalled and not returned” and “TV7” is “recalled and returned”. The process assumes “TV1” and “TV6” to match the condition. The process determines that the work histories for “TV1” and “TV6” on the second and sixth lines in FIG. 2 match the filtering condition.

The user having the user identifier “industry group Z” issues the work history reference request for “acquiring all work histories”. As a response, the process returns the past work histories concerning the objects that are currently recalled and not returned (Step 1005). Namely, the work histories contain “shipment” of “TV1” from “warehouse 1” to “shop X” conducted by “worker 1” at “11:00 on March 10” and “shipment” of “TV6” from “warehouse 4” to “shop X” conducted by “worker 4” at “12:00 on March 10”.

In this example, the state condition 94 in FIG. 5 is applied at the filtering stage (Step 1004). The state condition 94 may be applied at the work history acquisition stage (Step 1003). In this case, the work history table 1 may be searched without filtering based on a condition under which the classification in FIG. 2 is “shipment to shop X from warehouse 1” or “shipment to shop X from warehouse 4” and the object ID 31 in FIG. 6 equivalent to the object ID 13 matches the state 32 indicating “recalled and not returned”. The same result is generated independently of whether search results are filtered or the filtering condition is added to the search condition for searching.

It may be understood from the above-mentioned embodiment of the work history management apparatus that the work history management apparatus is useful for situations requiring users or a user group to reference a work history. For example, the work history management apparatus is useful for product distribution systems, traceability systems, and manufacturing systems that use work histories.

As mentioned above, the work history records “who”, “when”, “where”, “what”, and “how”. The above-mentioned work history management apparatus may be also used for intangible objects such as data and programs. In this case, the element “who” represents a user or a program that performs operations. The element “when” is equivalent to the time to update or reference data or a program. The element “where” may represent a storage device or a folder as well as a computer or a terminal used for a work. The element “what” represents data or a program. The element “how” represents update or reference. Based on these associations, the work history management apparatus may be used for such works as data update and program development.

The embodiment defines a reference condition for associating the classification corresponding to the work history content with a user or a user group that references the work history. When the user issues a work history reference request, the reference condition can be accordingly used to easily search the work history.

The embodiment provides the reference condition that associates the classification with the user. Setting of the reference condition eliminates the need for setting the reference right (access right) for each of varied work histories. The number of reference condition settings becomes smaller than that of reference right settings for each of work histories. This shortens the time required to determine availability of the reference.

The embodiment classifies a work history at the stage of registering the work history. The embodiment can reference the work history faster than a technology of classifying the work history at the stage of referencing the work history.

The embodiment further provides a filtering condition for filtering. Availability of the reference can be determined in consideration for the state of an object targeted for the work or the limitation on the time to reference the work history.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications within the ambit of the appended claims.

What is claimed is:

1. A work history management apparatus comprising:
a work history classification section that classifies a work history in accordance with a content of the work history and assigns a classification identifier;
a work history registration section that associates the classification identifier with the work history and stores the work history in a storage device; and
a work history reference section that responds to a work history reference request from a user, references a reference condition associating a user capable of referencing the work history with the classification identifier, and searches for the work history stored in the storage device so as to be able to be referenced by the user and correspond to the classification identifier.

2. The work history management apparatus according to claim 1,
wherein a content of the work history contains a work subject, a work date, a work place, a work object, and a work content.

3. The work history management apparatus according to claim 2,
wherein the reference condition contains a time condition associated with the classification identifier; and
wherein the work history reference section responds to the work history reference request, references the reference condition, and searches for the work history that is capable of being referenced by the user, corresponds to the classification identifier, allows the work date to satisfy the time condition, and is stored in the storage device.

4. The work history management apparatus according to claim 2,
wherein the reference condition contains a state condition of the work object associated with the classification identifier; and
wherein the work history reference section responds to the work history reference request, references the reference condition, and searches for the work history that is capable of being referenced by the user, corresponds to the classification identifier, allows a state of the work object to satisfy the state condition, and is stored in the storage device.

5. The work history management apparatus according to claim 2,
wherein the reference condition contains a filtering condition associated with the classification identifier; and
wherein the work history reference section uses the filtering condition to filter the searched-for work history.

6. The work history management apparatus according to claim 5,
wherein the filtering condition is equivalent to a time condition concerning the work date contained in the work history.

7. The work history management apparatus according to claim 5,
wherein the filtering condition is equivalent to a state condition of the work object contained in the work history.

8. A work history management apparatus comprising:
a storage device for storing a reference condition that associates a work history with a classification identifier corresponding to a user capable of referencing the work history and a content of the work history;
an input device for accepting a work history reference request from a user;
a central processing unit that assigns the classification identifier to the work history in accordance with a content of the work history, stores the work history in the storage device in association with the classification identifier assigned to the work history, references a reference condition stored in the storage device in response to the work history reference request, and searches for the work history stored in the storage device so as to be able to be referenced by the user and correspond to the classification identifier; and
an output device for outputting the searched-for work history.

9. The work history management apparatus according to claim 8,
wherein a content of the work history contains a work subject, a work date, a work place, a work object, and a work content.

10. The work history management apparatus according to claim 9,
wherein the reference condition contains a time condition associated with the classification identifier; and
wherein the central processing unit responds to the work history reference request, references the reference condition, and searches for the work history that is capable of being referenced by the user, corresponds to the classification identifier, allows the work date to satisfy the time condition, and is stored in the storage device.

11. The work history management apparatus according to claim 9,
wherein the reference condition contains a state condition of the work object associated with the classification identifier; and
wherein the central processing unit responds to the work history reference request, references the reference condition, and searches for the work history that is capable of being referenced by the user, corresponds to the classification identifier, allows a state of the work object to satisfy the state condition, and is stored in the storage device.

12. The work history management apparatus according to claim 9,
wherein the reference condition contains a filtering condition associated with the classification identifier; and
wherein the central processing unit uses the filtering condition to filter the searched-for work history.

13. The work history management apparatus according to claim 12,
wherein the filtering condition is equivalent to at least one of a time condition concerning the work date contained in the work history and a state condition of the work object contained in the work history.

14. A work history management method,
wherein a central processing unit is connected with a storage device for storing a reference condition that associates a work history with a classification identifier corresponding to a user capable of referencing the work history and a content of the work history, an input device for accepting a work history reference request from a user, and an output device; and
wherein the central processing unit assigns the classification identifier to the work history in accordance with a content of the work history, stores the work history in the storage device in association with the classification identifier assigned to the work history, references a reference condition stored in the storage device in response to the work history reference request, searches for the work history stored in the storage device so as to be able to be referenced by the user and correspond to the classification identifier, and outputs the searched-for work history to the output device.

15. The work history management method according to claim 14,
wherein a content of the work history contains a work subject, a work date, a work place, a work object, and a work content.

16. The work history management method according to claim 15,
wherein the reference condition contains a time condition associated with the classification identifier; and
wherein the central processing unit responds to the work history reference request, references the reference condition, and searches for the work history that is capable of being referenced by the user, corresponds to the classification identifier, allows the work date to satisfy the time condition, and is stored in the storage device.

17. The work history management method according to claim 15,
wherein the reference condition contains a state condition of the work object associated with the classification identifier; and
wherein the central processing unit responds to the work history reference request, references the reference condition, and searches for the work history that is capable of being referenced by the user, corresponds to the classification identifier, allows a state of the work object to satisfy the state condition, and is stored in the storage device.

18. The work history management method according to claim 15,
wherein the reference condition contains a filtering condition associated with the classification identifier; and
wherein the central processing unit uses the filtering condition to filter the searched-for work history.

19. The work history management method according to claim 18,
wherein the filtering condition is equivalent to at least one of a time condition concerning the work date contained in the work history and a state condition of the work object contained in the work history.
